(19) United States
(12) Patent Application Publication
(10) Pub. No.: US 2017/0179746 A1
(43) Pub. Date: Jun. 22, 2017

(54) BATTERY SHUTDOWN METHOD AND DEVICE AND MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Wei WANG, Beijing (CN); Liang XIAO, Beijing (CN); Fanbo KONG, Beijing (CN)

(21) Appl. No.: 15/239,046

(22) Filed: Aug. 17, 2016

Related U.S. Application Data
(63) Continuation of application No. PCT/CN2016/088830, filed on Jul. 6, 2016.

(30) Foreign Application Priority Data
Dec. 19, 2015 (CN) 2015109071628

(51) Int. Cl. H02J 7/00; H04B 1/3883

(52) U.S. Cl. CPC H02J 7/0063; H04B 1/3883

(57) ABSTRACT

Disclosed are a battery shutdown method, an electronic device and a mobile terminal. In this application, a shutdown command is broadcasted in a wireless manner, and the corresponding power supply connection of a battery of the mobile terminal is controlled in a disconnected state for a first predetermined period of time by a battery shutdown device receiving the shutdown command.

### CROSS REFERENCE TO RELATED APPLICATIONS

This application is a continuation of International Application No. PCT/CN2016/088830, filed on Jul. 6, 2016, which is based upon and claims priority to Chinese Patent Application No. 201510907162.8, entitled “Battery Shutdown Method and Device and Mobile Terminal”, filed on Dec. 9, 2015 in the State Intellectual Property Office of the People's Republic of China, the entire contents of which are incorporated herein by reference.

### TECHNICAL FIELD

The present application relates to the technology of electronic circuits, and, in particular, to a battery shutdown method and an electronic device and a mobile terminal.

### BACKGROUND

A built-in and non-removable battery is capable of reducing the size of a mobile terminal to a certain extent and providing more flexibility to the shape design thereof; therefore, more and more mobile terminals adopt such battery configuration manners.

Typically, in the assembly process or the subsequent repair process of a mobile terminal, the battery needs to be electrically disconnected from other circuits for a period of time (e.g., several hundred of milliseconds) so as to facilitate detection of the mobile terminal.

In the prior art, the above battery shutdown operation is realized usually by means of a contact or a mechanical switch arranged on the mobile terminal.

However, the inventor of the present application has found in the study that such a manner of realizing the battery shutdown operation by means of the contact or the mechanical switch has the problem of incorrect triggering of power interruption easily caused by unexpected touch on the contact or the mechanical switch. Moreover, it will occupy the external space of the mobile terminal to arrange the contact or the mechanical switch on the mobile terminal, producing a negative effect on the shape of the mobile terminal.

### SUMMARY

To this end, the present application provides a battery shutdown method, an electronic device and a mobile terminal in order to realize a shutdown operation without setting a contact or a mechanical switch to avoid incorrect triggering.

In the first aspect, there is provided an electronic device, including: at least one antenna device; at least one processor, and a storage which is communicated by at least one processor. Wherein, the at least one antenna device receives wireless signal sent by command transmission device which is located on the outside of a mobile terminal. The storage stores executable instructions by the at least one processor. The at least one processor executes the instructions so as to: decode the wireless signal and thus to obtain shutdown command; then output shutdown control signal based on the shutdown command; and then control the first predetermined period of time for disconnection of battery power supply according to the shutdown control signal.

In the second aspect, there is provided a mobile terminal, which includes:

a built-in battery; and

an electronic device. Wherein,

the electronic device includes: at least one antenna device, at least one processor, and a storage which is communicated by at least one processor. Wherein, the at least one antenna device receives wireless signal sent by command transmission device which is located on the outside of a mobile terminal. The storage stores executable instructions by the at least one processor. The at least one processor executes the instructions so as to: decode the wireless signal and thus to obtain shutdown command; then output shutdown control signal based on the shutdown command; and then control the first predetermined period of time for disconnection of battery power supply according to the shutdown control signal.

In the third aspect, provided is a battery shutdown method, which includes:

receiving a wireless signal sent by a command transmission device outside a mobile terminal, and decoding the wireless signal to obtain a shutdown command; and

controlling a power supply connection of the battery in a disconnected state for a first predetermined period of time according to the shutdown command.

The mobile terminal is added with the wireless communication module, and then controls the battery to be disconnected from other circuits (i.e., disconnecting the power supply connection of the battery) after receiving a wireless shutdown signal; therefore, the battery shutdown operation can be performed without the contact or the mechanical switch, and incorrect triggering can also be avoided. Moreover, the appearance design of the mobile terminal can be more flexible.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 schematically illustrates a structural block diagram of a battery shutdown control system in accordance with an embodiment of this application;

FIGS. 2a-2c schematically illustrates structural block diagrams of a battery shutdown device in accordance with at least one implementation manners of an embodiment of this application;

FIG. 3 schematically illustrates a flowchart of a battery shutdown method in accordance with an embodiment of this application;

FIG. 4 schematically illustrates hardware structure of an device which performs the method for disconnection of battery power supply provided by the embodiment in the present application.

### DETAILED DESCRIPTION

Exemplary embodiments of the present disclosure will be described below in more detail with reference to the accompanying drawings. Although the accompanying drawings show the exemplary embodiments of the present disclosure, it should be understood that the present disclosure can be implemented in various forms and should not be limited by the embodiments set forth herein. Conversely, the embodiments are provided to understand the present disclosure more thoroughly, and completely convey the scope of the present disclosure to a person skilled in the art. FIG. 1 schematically illustrates a structural block diagram of a battery shutdown control system in accordance with an embodiment of this application.

As shown in FIG. 1, the battery shutdown control system includes a command transmission device 1 and a battery shutdown device 2.

The command transmission device 1 is used for transmitting a wireless signal that carries a shutdown command. The shutdown command may be a predetermined binary code sequence.

Moreover, the wireless signal may be a signal based on an existing wireless communication interface, for example, a WiFi signal, a Bluetooth signal, an infrared signal, a 2.4 G wireless signal, a near-field communication (NEC) signal or other wireless signals based on self-defined communication protocols. Optionally, the wireless signal is a signal that is transmitted based on a near field communication protocol in which the communication distance is preferably within 10 cm. That is, the command transmission device 1 and the battery shutdown device 2 perform communication based on a near field communication protocol where a communication distance is less than a predetermined distance. Therefore, when it is required to perform manufacturing assembly or maintenance detection on mobile terminals one by one, a shutdown operation may be performed without incorrect triggering of other mobile terminals within the communication range.

The battery shutdown device 2 is provided in a mobile terminal T, where the mobile terminal T is provided with a built-in battery B and a power supply connection that is used to deliver electric energy of the battery to a circuit of the mobile terminal. That is, the mobile terminal T includes the built-in battery B and the battery shutdown device 2, and a primary functional circuit (may be also called a main-board) that is used for maintaining operation of the mobile terminal T, where the primary functional circuit may include for example, a power supply management circuit, a shutdown protection circuit, a primary functional circuit, a communication circuit, a display circuit and an I/O circuit. The mobile terminal may be a consumer electronics product having a data processing function, for example, a mobile communication terminal, or a tablet computer. In the mobile terminal, power is supplied to the primary functional circuit P and the battery shutdown device 2 by the battery B.

In this application, the “shutdown” refers to that an electric connection between the battery and other circuits inside the mobile terminal is disconnected.

The battery shutdown device 2 is used for receiving and decoding a wireless signal to obtain a signal command, and when the signal command is a shutdown command, a battery power supply is disconnected and the disconnected state will last for a first predetermined period of time. In an optional implementation manner, the battery shutdown device 2 can disconnect the power supply connection of the battery by using a switch that is provided on the power supply connection. In another preferable implementation manner, the battery shutdown device 2 uses a shutdown protection function in the mobile terminal to disconnect the power supply connection of the battery by triggering the shutdown protection function of the battery in the primary functional circuit. Specifically, the battery shutdown device 2 triggers the shutdown protection function by controlling the switch that is connected between a shutdown trigger pin and a positive electrode of the battery in an ON state or triggers the shutdown protection function for a predetermined time by directly outputting a high-level for the first predetermined period of time to the shutdown trigger pin. It should be understood that the shutdown protection function of the battery can be triggered in other existing manners according to the difference of actual configurations of the battery and the primary functional circuit.

In this embodiment, because the battery shutdown device 2 acquires electric energy by using the battery. Therefore, after the power supply connection of the battery is disconnected, the battery shutdown device 2 also loses power supply. In this case, to restore power supply of the battery after manufacturing or detection is completed, the battery shutdown device 2 can output a high-level or a low level for the first predetermined period of time by using a circuit having a self-powered function within the first predetermined time, where the circuit can maintain self operation for a predetermined time based on electric energy stored by at least one capacitor. The switch that controls a power supply line of the battery is controlled in an OFF state or the shutdown protection function of the battery is triggered; after the predetermined duration ends, because an electricity quantity decreases and the level is inverted, the power supply connection of the battery is re-conducted.

Hence, by broadcasting the shutdown command in a wireless manner, the battery shutdown device that receives the shutdown command is enabled to control the corresponding mobile terminal to disconnect the power supply connection of the battery and the state of disconnection will last for the first predetermined period of time. Hence, the battery shutdown operation can be performed without setting a contact or mechanical switch to avoid incorrect trigger. Moreover, the appearance design of the mobile terminal can be more flexible.

Further, in order to reduce the power consumption, the battery shutdown device 2 may be configured to receive a wireless signal at every second predetermined time interval (for example 5 minutes), and to decode after receiving the wireless signal to obtain the signal command. Within the interval between receptions, the battery shutdown device 2 is in an inactive state. Meanwhile, the power consumption of the battery shutdown device 2 may be further reduced by selecting a wireless communication mode and circuit arrangement mode with relatively low power consumption, so as to minimize the influence on the endurance performance of the mobile terminal caused by adding wireless reception functions on the endurance performance of the mobile terminal.

Further, in order to allow the command transmission device to obtain a state of shutdown operation, the battery shutdown device 2 may be configured to transmit a confirmation signal after receiving the shutdown command. The confirmation signal is transmitted in a wireless broadcasting manner or on the basis of an ID of command transmission device 1 carried in the shutdown command. After receiving the confirmation signal, the command transmission device 1 may stop transmitting the wireless signal. Thus, on one hand, the power consumption of the transmission side can be reduced, on the other hand, the success of shutdown operation is prompted on one side of the command transmission device 1 based on the confirmation signal, so that a desired operation of off-service detection or assembly may be performed automatically or under manual control.

Specifically, the command transmission device 1 may receive the wireless signal within the interval between two wireless signal transmissions.

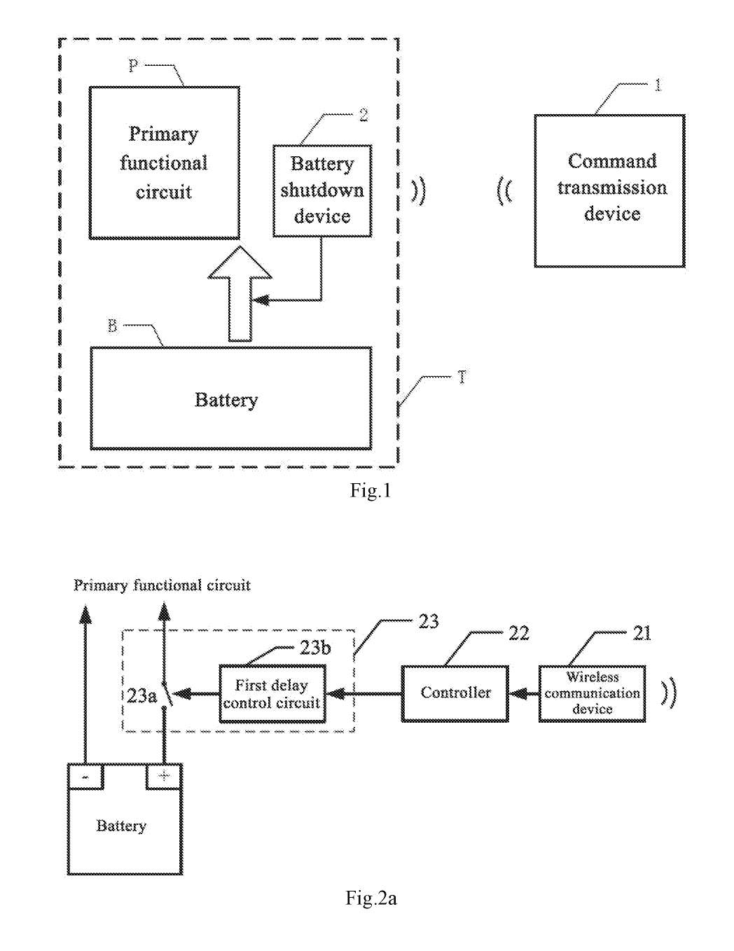

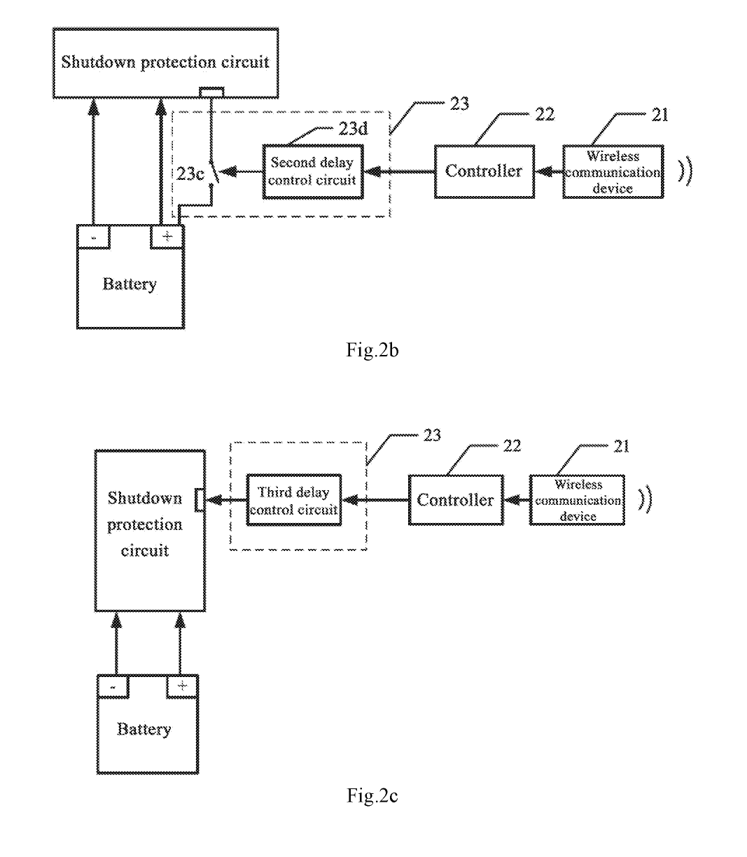

FIGS. 2a-2c schematically illustrates a structural block diagram of a battery shutdown device in several alternative embodiments of the application.

As shown in FIGS. 2a-2c, the battery shutdown device 2 includes a wireless communication module 21, a controller 22 and a shutdown control circuit 23.

The wireless communication module 21 is used for receiving and decoding a wireless signal sent by a command transmission device outside a mobile terminal to obtain a shutdown command. Wherein, the wireless signal may be a signal based on an existing wireless communication interface, for example, a WiFi signal, a Bluetooth signal, an infrared signal, a 2.4 G wireless signal, a near-field communication (NFC) signal or other wireless signals based on self-defined communication protocols. Alternatively, the wireless signal is a signal that is transmitted based on a near field communication protocol in which the communication distance is preferably within 10 cm. Therefore, when it is required to perform manufacturing assembly or maintenance detection on mobile terminals one by one, a shutdown operation may be performed without triggering, by mistake, other mobile terminals within the communication range.

The controller 22 is connected to the wireless communication module 21 and the shutdown control circuit 23, for outputting a shutdown control signal according to the shutdown command to control the shutdown control circuit 23 to disconnect the power supply connection of the battery, and the state of disconnection will last for a first predetermined period of time. Wherein, the shutdown command may be a predetermined binary code sequence. The controller 22 outputs the shutdown control signal when detecting the predetermined binary code sequence. The shutdown control signal may be a pulse signal for triggering purpose.

The shutdown control circuit 23 is used for disconnecting the power supply connection of the battery for a first predetermined period of time. Optionally, the shutdown control circuit 23 may work in a low-voltage drive state to enable a primary functional circuit P to reset, and preferably the voltage is below 1.5 V.

In an alternative example, as shown in FIG. 2a, the shutdown control circuit 23 includes a first switch 23a provided on the power supply connection and a first delay control circuit 23b. The first delay control circuit 23b is used for outputting a high-level lasting for a first predetermined time in response to the shutdown control signal from the controller 22. As the first delay control circuit 23b does not require relatively high power consumption, one capacitor element for energy storage may be provided for power supply within the first predetermined time. Within the first predetermined time, the capacitor element discharges to maintain the high-level, and after the first predetermined time, the voltage of the capacitor element drops and is insufficient to support the operation of the first delay control circuit 23b, as a result, the outputted high-level is switched into a low-level. Thus, the shutdown control circuit 23 may keep working without power supply from the outside within a short period of time. Under the control of the high-level, the first switch 23a remains off within the first predetermined time, so that the power supply connection is disconnected between a battery B and other circuits. After the first predetermined time, the power supply connection may be recovered.

In another alternative embodiment, the shutdown protection circuit 22 includes a second switch 23c that is connected between a positive electrode of the battery and a shutdown protection triggering end of a power control circuit, and a second delay control circuit 23d. The second delay control circuit 23d is used for outputting a high-level lasting for a first predetermined period of time in response to triggering the shutdown control signal from the controller 22. Under the control of the high-level, the second switch 23c is turned ON in a first predetermined period of time, so that the communication occurs between the shutdown protection triggering end and the positive electrode of the battery, the shutdown protection function is triggered, and the power supply connection between the battery B and other circuits is disconnected. After a first predetermined time, the second switch 23c is turned OFF to disable shutdown protection, so that the power supply connection may be recovered.

In another alternative embodiment, the shutdown control circuit 23 includes a third delay control circuit that outputs a high-level lasting for a first predetermined period of time in response to triggering the shutdown control signal from the controller 22, the high-level is outputted to the shutdown protection circuit to trigger the shutdown control function, so that power supply connection is disconnected between a battery B and other circuits within the first predetermined time. After the first predetermined time, power supply connection may be recovered.

Therefore, the battery shutdown operation may be performed without setting a contactor or a mechanical switch to avoid incorrect triggering. Moreover, the appearance design of the mobile terminal can be more flexible. During assembly and maintenance, the shutdown operation may be realized by a battery shutdown device 2 which is built in the mobile terminal.

Meanwhile, in order to reduce the system power consumption, the wireless communication module 21 may be configured to receive a wireless signal at every second predetermined time interval (for example 5 minutes), and to decode after receiving the wireless signal to obtain the signal command. Within the interval between two wireless receptions, the controller 22 controls the wireless communication module 21 in an inactive state.

Further, in order to enable a command transmission unit to obtain a state of shutdown operation, the controller 22 is arranged to control the wireless communication module 21 to transmit a confirmation signal after receiving a shutdown command. The confirmation signal is used for prompting the completion of shutdown operation to the command transmission device 1. After receiving the confirmation signal, the command transmission device 1 may stop transmitting the shutdown command. And the completion of shutdown operation may be prompted via the human-machine interface, or the manufacturing or detection operation may be initiated under the manner of automatic control.

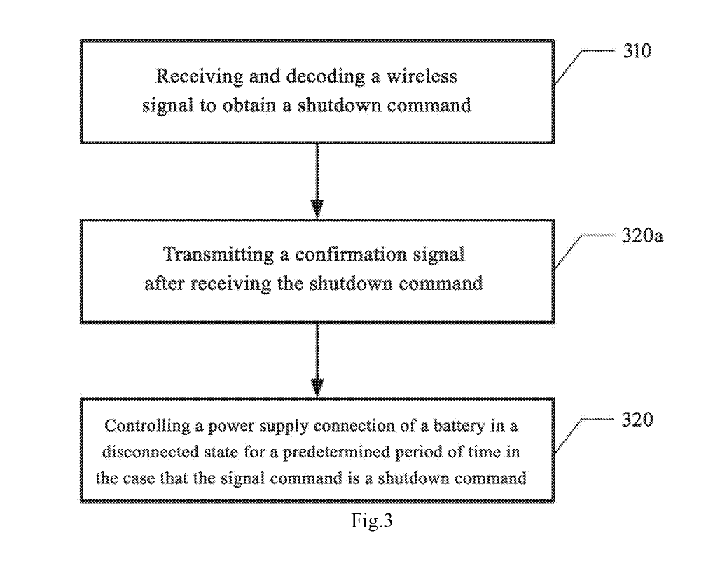

FIG. 3 schematically illustrates a flow chart of a battery shutdown method of an example of the disclosure.

As shown in FIG. 3, the method allows the shutdown operation by communication between a command transmission device and a battery shutdown device, including:

Step 310, receiving a wireless signal sent by a command transmission device of a wireless transmitter outside a mobile terminal, and decoding the wireless signal to obtain a shutdown command.

Optionally, receiving wireless signals at every second predetermined time interval (for example 5 minutes) to reduce the system power consumption.

Step 320, controlling disconnection of the power supply of the battery for a first predetermined period of time according to the shutdown command.

Specifically, the shutdown command may be a predetermined binary code sequence.

In an alternative example, in step 320, controlling disconnection of the power supply of the battery for a first predetermined period of time may also be implemented by controlling disconnection of a first switch connected to the power supply connection of the battery for the first predetermined period of time.

In another alternative example, in step 320, controlling disconnection of the power supply of the battery for a first predetermined period of time may be implemented by controlling the positive electrode of the battery and the triggering end of a shutdown protection circuit in a short-circuited state for the first predetermined period of time.

In yet another alternative example, controlling a power supply connection of the battery in a disconnected state for a first predetermined period of time may be implemented by outputting a high-level to a triggering end of the shutdown protection circuit for a first predetermined period of time.

Further, in order to allow the command transmission unit to obtain the condition of shutdown operation, the method also includes step 320a, that is, in which the battery shutdown device transmits a confirmation signal after receiving the shutdown command. The confirmation signal is used for prompting the completion of shutdown operation to the command transmission device 1. The step 320a may be carried out at the same time as or prior to the step 320. After receiving the confirmation signal, the command transmission device may stop transmitting the shutdown command. And the completion of shutdown operation may be prompted via the human-machine interface, or the manufacturing or detection operation may be initiated under the manner of automatic control.

Thus, the shutdown command is broadcast in a wireless manner, and the power supply connection of the battery to the corresponding mobile terminal is disconnected by the battery shutdown device receiving the shutdown command. Therefore, the battery shutdown operation may be performed without setting a contactor or a mechanical switch to avoid incorrect triggering. Moreover, the appearance design of the mobile terminal can be more flexible.

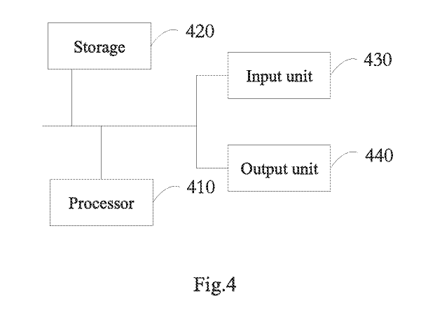

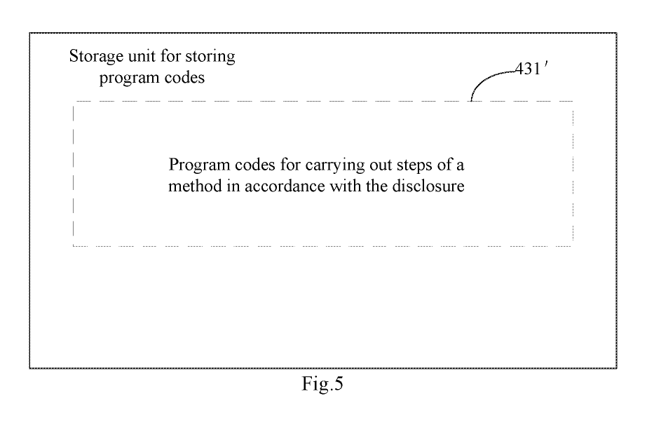

FIG. 4 schematically illustrates hardware structure of a device which performs the method for disconnection of battery power supply provided by the embodiment in the present application. As shown in FIG. 4, a device includes:
One or more antenna device (unshown in FIG. 4),
One or more processor 410, and
a storage 420. One processor is taken for example in FIG. 4.
The device performing the method for disconnection of battery power supply may also include: input unite 430 and output unit 440.

Processor 410, the storage 420, input unit 430 and output unit 440 can be connected to each other through data bus or other means of connection, and data bus is shown in FIG. 4 for an example. Storage 420 can be used for storing non-transitory software program, non-transitory computer executable program and modules as a non-transitory computer-readable storage medium, such as corresponding program instructions/modules for the method for battery shutdown mentioned by embodiments of the present disclosure. Processor 410 performs various function application and data processing by executing non-transitory software program, instructions and modules which are stored in storage 420, i.e. to realize the performing methods mentioned by embodiments of the present disclosure.

Storage 420 can include program storage area and data storage area, thereby the operating system and applications required by at least one function can be stored in program storage area and data created by using the device performing the mentioned operation can be stored in data storage area. Furthermore, storage 420 can include high speed Random-access memory (RAM) or non-volatile memory such as magnetic disk storage device, flash memory device or other non-volatile solid state storage devices. In some embodiments, storage 420 can include long-distance setup memories relative to processor 410, which can communicate with the device by networks for performing the mentioned operation. The examples of said networks are including but not limited to Internet, Intranet, LAN, mobile Internet and their combinations.

Input unit 430 can be used to receive input digital, character information and key signals causing user configuration and function control of the device for performing the mentioned operation. Output unit 440 can include a display screen or a display device.

The said one or plural modules are stored in storage 420 and perform the methods for disconnecting battery power supply when executed by one or plural processors 410.

The said device can reach the corresponding advantages by including the function modules or performing the methods provided by embodiments of the present disclosure. Those methods can be referenced for technical details which may not be completely described in this embodiment.

Electronic device in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-15. (canceled)

16. An electronic device, which includes:
at least one antenna device,
at least one processor, and
a storage which is communicated by at least one processor.
Wherein, the at least one antenna device receives wireless signal sent by command transmission device which is located on the outside of a mobile terminal.
The storage stores executable instructions by the at least one processor.
The instructions are executed by the at least one processor executes so as to:
decode the wireless signal and thus to obtain shutdown command; then
output shutdown control signal based on the shutdown command; and then
control the first predetermined period of time for disconnection of battery power supply according to the shutdown control signal.

17. The electronic device according to claim 16, wherein, the first predetermined period of time for disconnection of battery power supply according to the shutdown control signal includes:
a first predetermined period of time in an OFF state of a first switch according to the shutdown control signal. The first switch is connected to the power supply connection of the battery.

18. The electronic device according to claim 16, wherein, the first predetermined period of time for disconnection of battery power supply according to the shutdown control signal includes:
a first predetermined period of time in an ON state of a second switch according to the shutdown control signal. The second switch is connected between a positive electrode of the battery and a triggering end of a shutdown protection circuit of the mobile terminal.

19. The electronic device according to claim 16, wherein, the first predetermined period of time for disconnection of battery power supply according to the shutdown control signal includes:
outputting a high-level lasting for a first predetermined period of time to triggering pin of the shutdown protection circuit of mobile terminal.

20. The electronic device according to claim 16, wherein, the instructions enable the at least one processor to receive wireless signals at every second predetermined time interval.

21. The electronic device according to claim 16, wherein, the instructions enable the at least one processor to send a confirmation signal after receiving the shutdown command.

22. The electronic device according to claim 16, wherein, the wireless signal is a signal transmitted based on a near field communication protocol where a communication distance is less than a predetermined distance.

23. A mobile terminal, characterized by comprising:
a built-in battery; and
an electronic device which includes:
at least one processor, and
a storage which is communicated by at least one processor.
Wherein, the at least one antenna device receives wireless signal sent by command transmission device which is located on the outside of a mobile terminal.
The storage stores executable instructions by the at least one processor.
The instructions are executed by the at least one processor executes so as to:
decode the wireless signal and thus to obtain shutdown command; then
output shutdown control signal based on the shutdown command; and then
control the first predetermined period of time for disconnection of battery power supply according to the shutdown control signal.

24. The mobile terminal according to claim 23, wherein, the first predetermined period of time for disconnection of battery power supply according to the shutdown control signal includes:
a first predetermined period of time in an OFF state of a first switch according to the shutdown control signal. The first switch is connected to the power supply connection of the battery.

25. The mobile terminal according to claim 23, wherein, the first predetermined period of time for disconnection of battery power supply according to the shutdown control signal includes:
a first predetermined period of time in an ON state of a second switch according to the shutdown control signal. The second switch is connected between a positive electrode of the battery and a triggering end of a shutdown protection circuit of the mobile terminal.

26. The mobile terminal according to claim 23, wherein, the first predetermined period of time for disconnection of battery power supply according to the shutdown control signal includes:
outputting a high-level lasting for a first predetermined period of time to triggering pin of the shutdown protection circuit of mobile terminal.

27. The mobile terminal according to claim 23, wherein, the instruction enables the at least one processor to receive wireless signals at every second predetermined time interval.

28. The mobile terminal according to claim 23, wherein, the instruction enables the at least one processor to send a confirmation signal after receiving the shutdown command.

29. A battery shutdown method, which includes:
receiving a wireless signal sent by a command transmission device outside a mobile terminal, and decoding the wireless signal to obtain a shutdown command; and
controlling a power supply connection of the battery in a disconnected state for a first predetermined period of time according to the shutdown command.

30. The battery shutdown method according to claim 29, wherein, controlling a power supply connection of the battery in a disconnected state for a first predetermined period of time includes:
controlling a first switch that is connected to the power supply connection of the battery in an OFF state for the first predetermined period of time.

31. The battery shutdown method according to claim 29, wherein, controlling a power supply connection of the battery in a disconnected state for a first predetermined period of time includes:
controlling a positive electrode of the battery and a triggering end of a shutdown protection circuit in a short-circuited state for the first predetermined period of time.

32. The battery shutdown method according to claim 29, wherein, controlling a power supply connection of the battery in a disconnected state for a first predetermined period of time includes:
outputting a high level last for the first predetermined period of time to a triggering end of a shutdown protection circuit.

33. The battery shutdown method according to claim 29, wherein, receiving a wireless signal sent by a command transmission device outside the mobile terminal includes:
receiving wireless signals at every second predetermined time interval.

34. The battery shutdown method according to claim 29, which further includes:
transmitting a confirmation signal after receiving the shutdown command.

35. The battery shutdown method according to claim 29, wherein, the wireless signal is a signal transmitted based on a near field communication protocol where a communication distance is less than a predetermined distance.
